(19) United States
(12) Patent Application Publication
(10) Pub. No.: US 2006/0000784 A1
(43) Pub. Date: Jan. 5, 2006

(54) Water treatment

(76) Inventor: Boris Mikhailovich Khudenko, Atlanta, GA (US)

Correspondence Address: Boris M. Khudenko, 744 Moores Mill Rd., Atlanta, GA, 30327, US

(21) Appl. No.: 10/881,577

(22) Filed: Jun. 30, 2004

(51) Int. Cl. C02F 1/46

(52) U.S. Cl. 210/748

(57) ABSTRACT

This is a method of water and wastewater treatment for removal of pollutants in at least two-step process comprising (a) treatment of water producing at least partially treated intermediate effluent, (b) treatment of the intermediate effluent with a sacrificial metal and producing ions of said sacrificial metal, and providing very thoroughly treated effluent, (c) recuperating sacrificial metal ions generated in the step (b) and recycling the recuperated ions in the step (a), the recuperated and recycled ions from the step (c) improve treatment efficiency of step (a) by additionally removing pollutants from the intermediate effluent using recuperated ions, resulting in cleaner intermediate effluent, and, therefore, the pollutant loading rate in step (b) is reduced, intermediate effluent is further treated more thoroughly, and the demand for the sacrificial metal in step (b) is reduced. Step (a) can preferably be a biological, biological-abiotic, physical chemical, or combination of these steps. Step (b) is preferably a spontaneous cementation-driven electrochemical process. The combination of said steps (a), (b) and (c) produces a synergistic effect resulting in improved removal of said pollutants and in reduced need in said sacrificial metal. For example, a drinking quality water can be very economically and reliably obtained from wastewater. In addition to the superb treatment efficiency and reduced reagent requirements, the waste sludge from the system is beneficially disposed in-sewers, in sanitary landfills or on land.

### FIELD OF INVENTION

The invention belongs to a multi-step methods of water treatment with at least one step after the first step being an electrochemical step generating metal ions that are recuperated and reused in at least one of the previous stages. The method can be used for treatment of water, wastewater, aqueous process solutions in municipal, industrial, and agricultural systems.

### PRIOR ART

Multi-step water and wastewater treatment systems are well known. For example, water treatment train may include one or several steps of biological treatment of wastewater for reducing the bulk of organics, suspended solids, and a part of nitrogen and phosphorus, following by physical chemical treatment with iron or aluminum salts to additionally remove suspended solids and nutrients, primarily phosphorus. The fundamental problem with this method is that the principle of adding on processes and equipment prevail in most upgrades and developments of advanced systems for meeting new discharge requirements. Particularly, biological sludges in each biological stage, chemical sludges in coagulation-settling (or other separation) and in precipitation-separation processes are discarded from each stage without considering any benefits that could be derived from these sludges in other process stages. For example, in system for phosphorus removal after biological process, the excess biomass is removed from the biological process steps in the water train and chemical sludge is removed from the water train separately and directed to the sludge treatment train. These process stages produce additive effect and do not mutually improve performance of each other. Similar approach is used in water purification: In the initial process steps, the raw water from a lake or river is coagulated, flocculated, and clarified, usually by gravity settling. The bulk of suspended solids, and some of the dissolved organics and color are removed. In the subsequent steps, water is filtered to thoroughly remove suspended solids. Powdered activated carbon and strong oxidizers, usually permanganate, can be added to the initial or final process stages. The gravity settled chemical sludge and the filter backwash flow are removed from the water treatment sequence separately and there is no any mutually beneficial interaction between the process steps. Disinfection by chlorination is a very common practice for water and many wastewater treatment systems. The chlorination step also does not effect the preceding steps. The prevalent add-on principle of development of new systems results in very complex systems and in great cost increases.

The objective of the present invention is to provide a multistage method of water and wastewater treatment wherein a synergy is established between the steps and the efficiency of these steps is increased, while the treatment cost is decreased.

Another objective of this invention is to provide a simple system capable of supplanting the present large add-on systems.

Other objectives of the present invention will become apparent from the ensuing description.

### SUMMARY OF INVENTION

This is a method of water and wastewater treatment for removal of pollutants comprising steps of
(a) treatment of said water producing an intermediate effluent, whereby said pollutants are at least partially removed,
(b) treatment of said intermediate effluent with a sacrificial metal and producing ions of said sacrificial metal, whereby a thoroughly treated effluent is produced,
(c) recuperating said sacrificial metal ions generated in said step (b) and recycling said recuperated ions in said step (a),
whereby said recuperated and recycled ions from said step (c) improve treatment efficiency of step (a) by additionally removing said pollutants from said intermediate effluent using said recuperated ions, resulting in cleaner intermediate effluent, and
whereby, due to said cleaner intermediate effluent, the pollutant loading rate in said step (b) is reduced, intermediate effluent is further treated more thoroughly, and the demand for said sacrificial metal in said step (b) is reduced, and
whereby the combination of said steps (a), (b) and (c) produces a synergistic effect resulting in improved removal of said pollutants and in reduced need in said sacrificial metal.

The water and/or wastewater can be sewage, wastewater, domestic wastewater, municipal wastewater, industrial wastewater, commercial wastewater, animal farm wastewater, agricultural wastewater, wastewater from ground transportation vehicles, wastewater in space ships, partially treated wastewater, wastewater sludge, biosolids, storm water, surface runoff, water from surface water supply sources, river water, lake water, brackish water, sea water, industrial process water, water in industrial cooling systems, water in industrial cooling systems with recirculation, water as a solvent in industrial systems, water as a carrier in industrial systems, irrigation water, mine waters, and combinations thereof. It is understood that any water and wastewater type in any industry and in the environment can be included herein in the definition of water.

The pollutants can be nonionic species, ionic species, ionized species, non-ionized species, organic compounds, toxic organic compounds, recalcitrant organic compounds, inorganic compounds, toxic inorganic compounds, heavy metals, toxic oxygen containing ions, hydrides, dissolved substances, suspended solids, solid particles, flocculent particles, polymeric substances, nutrients, bound nitrogen, organic nitrogen, inorganic nitrogen, ammonia, nitrites, nitrates, phosphorus-containing compounds, organic phosphorus, inorganic phosphorus, phosphates, microorganisms, protozoa, bacteria, viruses, and combinations thereof.

The sacrificial metal is selected from the group comprising iron, nickel, cobalt, zinc, aluminum, copper, and combinations thereof. In most cases, iron is preferred. Iron scrap can also be used.

The step (a) can be a chemical treatment, an oxidation-reduction treatment, a treatment involving acid-base interactions, a formation of insoluble compounds, a chemical precipitation, a coagulation, a flocculation, a gravity settling, a flotation, a filtration, a membrane filtration, an electrochemical treatment, a magnetic treatment, a biological treatment, a biological-abiotic treatment, and combinations thereof.

The step (b) can be an electrochemical treatment, an electrochemical treatment with direct current, an electrochemical treatment with alternating current, an electrochemical treatment with pulsed current, an electrochemical treatment with cementation induced reactions, a spontaneous electrochemical treatment, an electrochemical treatment with spontaneously induced galvanic cell, an electrochemical treatment with primed sacrificial metal, an electrochemical treatment with activated sacrificial metal, an electrochemical oxidation-reduction treatment, an electrochemical treatment involving acid-base interactions, an electrochemical treatment involving formation of insoluble compounds, an electrochemical precipitation, an electro coagulation, an electro flocculation, a treatment with pondermotive forces, a treatment with electrophoresis, a treatment with electro dialysis, a treatment in strong electromagnetic fields, a treatment in plasma streamers, a particle interception in electromagnetic fields, and combinations thereof.

The possible biological and biological-abiotic methods for conducting step (a) are described in the U.S. Pat. Nos. 4,472,358, 4,482,510, 5,514,277, 5,514,278, 5,616,241, 5,698,102, 5,798,043, 5,846,424, 5,919,367, 6,004,456, 6,015,496.6,048,459,6,220,822. The possible arrangements of the electrochemical process steps are described in the U.S. Pat. Nos. 5,348,629 and 5,879,555. These patents are made part of the present specification by inclusion.

### PREFERRED EMBODIMENTS

The present method can be adopted to many applications. Only two applications are described herein: biological-abiotic treatment of wastewater combined with the cementation-driven electrochemical treatment of materials, and water purification using coagulation-flocculation combined with the cementation driven electrochemical treatment of materials. The term combined as used herein means that the process stages or steps actively interact with the feed forward and feed back interactions that enhance the performance of these steps. Such mutual enhancement can also be called the synergistic effect.

Biological-Abiotic and Electrochemical Steps, Wastewater Treatment

The first embodiment includes two major treatment steps: a biological step and an electrochemical step. The biological treatment step is enhanced by iron ions. In such a process, iron ions are at least partially oxidized to trivalent state (ferric ions) in aerobic or aerated steps and at least partially reduced to divalent state (ferrous ions) in anaerobic, facultative, and anoxic steps. At pH values typical for biological treatment, the ferric and ferrous ions form insoluble hydroxides and become embedded in the biomass. Recycle of the biomass between aerated and nonaerated zones, or exposure of it to higher and lower ORP conditions results in ferric-ferrous cycling. Ferric ions oxidize organics, including toxic and recalcitrant, in wastewater and some biomass mainly to water and carbon dioxide, ammoniais oxidized to nitrogen, and hydrogen sulfide is oxidized to sulfate. In specific applications, other oxidation reactions can also occur. Ferrous ions reduce nitrates and nitrites to nitrogen. Other reduction reactions obvious to skilled in arts are also possible. The reactions that may occur depend on thermodynamic properties of reacting constituents. Some of iron ion reactions are catalyzed by enzymes, while other reactions can be chemical interactions. Accordingly, iron ions enhance the biological treatment process.

The second, electrochemical, step follows the biological-abiotic step. The second step can be, for example, a cementation-driven spontaneous electrochemical process making use of sacrificial iron. Iron scrap or specially prepared iron pieces can be used. Sacrificial iron is activated preferably by ferric ions. Ferric ions can be fed as a solution of a ferric salt or formed internally in the process by oxidizing metallic iron and the ferrous ions emitted in the solution. Suitable oxidizers include oxygen, oxygen-containing anions, active chlorine. Metallic iron and ferrous ions can also be oxidized by applying electric tension to the sacrificial metal. The iron activation produces multiple galvanic cells with very high electrical potentials capable of producing microscopic plasma streamers and strong electromagnetic fields and pondermotive forces at the iron surface. Galvanic cells include multiple anodic and cathodic sites on the iron surface. Accordingly, organic compounds, including recalcitrant and toxic) in contact with the sacrificial iron are largely destroyed. Particularly, COD (or concentration of organics) of biologically treated effluent (after first step) can be further reduced to a range from few nanograms (ppb) to few milligrams (ppm) per liter. Microorganisms, including viruses, are also destroyed in this steps. Heavy metals more electropositive than iron (copper, lead, mercury) will be precipitated. Ammonia will be oxidized at anodic sites and nitrites and nitrates will be reduced at cathodic sites, thus nitrogen compounds in the final effluent will be virtually eliminated. Phosphates will react with iron ions and become precipitated. Strong electromagnetic forces and galvanic cells produce areas of low pH and elevated pH. At low pH, phosphates have lesser competition with hydroxide ions for binding to iron ions, accordingly, phosphate removal does not require significant iron excess above the stoichiometric ratio.

Considering that many wastewater treatment plants use chlorine gas, clorine dioxide gas, or hypochlorites for disinfection, active chlorine forms can also be used for activating the sacrificial iron. Note that some chlorinated organics may be produced, however, they will immediately be reduced by the sacrificial iron. The chlorinated organics will also constitute the activating agent. The use of active chlorine can be periodic. The existing chlorine preparation and feed systems can be used.

The sacrificial iron is gradually spent and becomes iron ions. Iron ions are dislodged from the sacrificial iron and separated in form of iron hydroxide flocculent sludge. If needed, the liquid carrying the dislodges iron ions is aerated to strip carbon dioxide and thus to rise pH and to oxidize ferrous ions to ferric thus reducing iron solubility. Instead of the conventional discarding of the iron sludge, it is directed into the biological process step (first step). This iron does not cost anything and improves the treatment efficiency.

The iron transferred from the second to the first process step further improves the removal of organics, suspended solids, and nutrients in the first stage. Accordingly, the concentrations and the respective mass of these pollutants that needs to be treated and removed in the second process step (electrochemical with the sacrificial metal) will be less than that without the recycle of the iron ions to the first step. Therefore, the sacrificial iron requirements will reduce, the final treatment efficiency increase, and the process cost will be reduced.

The described system can produce an equivalent of the drinking water quality or better from virtually any wastewater that is presently treated biologically. Such treated wastewater can be reused for virtually any purpose and discharged in virtually any natural water body. It can improve main production processes, for example allow the use of chlorine for bleaching paper, since chlorinated organics will be destroyed by the sacrificial iron anyway. Additionally, persistent wastewater color in pulp and paper wastewater can be completely (99 to 100%) eliminated. Removal of color due to persistent organics and removal of other recalcitrant constituents can eliminate many restrictions on the use of municipal sewer systems by many industries. The effect of combining the described biological-abiotic and electrochemical steps as compared with non-interactive coupling of these steps is tremendous and makes the described very thorough treatment economically feasible. This system is also very simple. The cost of this treatment is about an order of magnitude less than the costs of presently used methods.

The wastewater treated in the first described embodiment can be sewage, domestic wastewater, municipal wastewater, industrial wastewater, commercial wastewater, animal farm wastewater, agricultural wastewater, wastewater from ground transportation vehicles, wastewater in space ships, partially treated wastewater, wastewater sludge, biosolids, storm water, surface runoff, water from surface water supply sources, river water, lake water, brackish water, sea water, industrial process water, water in industrial cooling systems, water in industrial recycle cooling systems, water as a solvent in industrial systems, water as a carrier in industrial systems, irrigation water, mine waters, and combinations thereof.

This embodiment can be used to treat pollutants such as organic compounds, inorganic compounds, dissolved substances, suspended solids, solid particles, flocculent particles, polymeric substances, microorganisms, protozoa, bacteria, viruses, bound nitrogen, organic nitrogen, inorganic nitrogen, ammonia, nitrites, nitrates, phosphorus-containing compounds, organic phosphorus, phosphates, and combinations thereof.

The iron ions are intermittently oxidized to ferric and reduced to ferrous ions, whereby ferric and ferrous ions enhance biological oxidation and reduction of organics, reduce biomass generation, at least partially remove nitrogen and phosphorus, color, sulfides, and flocculate particulate materials. Sulfide binding also eliminates the sulfide odor.

The biological or biological-abiotic methods can be suspended growth processes, attached growth processes with fixed growth media, attached growth with moving media, attached growth with granular bed media, attached growth with sand media, attached growth with anthracite media, attached growth with backed clay media, attached growth with stone media, attached growth with plastic media, oxygen enhanced aerobic processes, aerobic processes, microaerophylic processes, ferrous ion oxidation processes, nitrification processes, fermentation processes, acidogenic processes, facultative processes, denitrification processes, sulfate reducing processes, carbonate reducing processes, water reducing processes, methanogenic processes, anaerobic processes, biological-abiotic treatment, and combinations thereof. Intermittent processes with various combinations of mixing, aeration, and idle periods, as well as decanting periods can also be used. The processes can be run in continous, batch, and semicontinous modes.

The second treatment step can be electrochemical treatment, electrochemical treatment with direct current, electrochemical treatment with alternating current, electrochemical treatment with pulsed current, electrochemical treatment with cementation induced reactions, spontaneous electrochemical treatment, electrochemical treatment with spontaneously induced galvanic cell, electrochemical treatment with primed sacrificial metal, electrochemical treatment with activated sacrificial metal, electrochemical oxidation-reduction treatment, electrochemical treatment involving acid-base interactions, electrochemical treatment involving formation of insoluble compounds, electrochemical precipitation, electro coagulation, electro flocculation, treatment with pondermotive forces, treatment with electrophoresis, treatment with electro dialysis, treatment in strong electromagnetic fields, treatment in plasma streamers, particle interception in electromagnetic fields, and combinations thereof.

Physical Chemical—Electrochemical Steps, Water Purification

The second embodiment also includes two major treatment steps: a physical chemical treatment of raw water producing intermediate effluent and at least partial removal of pollutants, and a treatment of the intermediate effluent with participation of the sacrificial metal (preferably, iron) with production of the sacrificial metal ions, wherein a thoroughly treated effluent is produced. The metal ions derived from the dissolution of the metallic iron are recuperated after the second step and recycled in the first treatment step (physical chemical).

The recuperated and recycled metal ions from the second step are in the form of iron hydroxide flocks. In the first step, iron flocks coagulate suspended solids, organics, including color impairing organics such as humic and fulvic substances, and improve treatment efficiency of the first step. The pollutant loading rate in the second step is reduced, intermediate effluent is treated more thoroughly, and the demand for said sacrificial metal in the second step is reduced. Accordingly, the performance of the first step is improved by the iron ions supplied from the second step virtually for free, and the efficiency of the second step is improved because the first step treats the raw influent better and produces better treated intermediate effluent. The combination of the first and the second steps with the reuse of iron ions produces a synergistic effect improves the removal of pollutants and reduces the need in said sacrificial metal. Considering very low concentration of organics in the treated effluent (from few parts per billion to few parts per million, or several orders of magnitude less than in the best conventional systems) the heterotrophic biological growth (including pathogens) in the water distribution networks is virtually eliminated. Moreover, virtually complete removal of nutrients (nitrogen and phosphorus) further suppresses the biological growth of autotrophic and heterotrophic organisms. Under such conditions, the dosages of chlorine are greately reduced. At very low organics and chlorine concentrations in pipelines, the potential for the formation of halogenated organics are extremely low.

Similarly to the first embodiment, the iron ions in the first step can be cycled between ferric and ferrous ions thus partially oxidizing and reducing some organic constituents, improving coagulation and flocculation of suspended solids, partially removing ammonia, and nitrites and nitrates, partially precipitating phosphorus. In some process arrangements, for example with biofiltration steps combined with physical chemical steps, biological transformations, as described above for the first embodiment, can also occur. The use of iron as a coagulant in this process is also prospective because aluminum (more common coagulant today) is associated with certain health problems.

The raw water treated in this process can be sewage, wastewater, domestic wastewater, municipal wastewater, industrial wastewater, commercial wastewater, animal farm wastewater, agricultural wastewater, wastewater from ground transportation vehicles, wastewater in space ships, partially treated wastewater, wastewater sludge, biosolids, storm water, surface runoff, water from surface water supply sources, river water, lake water, brackish water, sea water, industrial process water, water in industrial cooling systems, water in industrial cooling systems with recirculation, water as a solvent in industrial systems, water as a carrier in industrial systems, irrigation water, mine waters, and combinations thereof.

The pollutants treated by this method may include organic compounds, inorganic compounds, heavy metals, dissolved substances, suspended solids, solid particles, flocculent particles, polymeric substances, microorganisms, protozoa, bacteria, viruses, and combinations thereof.

The following electrochemical methods can be used in the second step: electrochemical treatment with direct current, electrochemical treatment with alternating current, electrochemical treatment with pulsed current, electrochemical treatment with cementation induced reactions, spontaneous electrochemical treatment, electrochemical treatment with spontaneously induced galvanic cell, electrochemical treatment with primed sacrificial metal, electrochemical treatment with activated sacrificial metal, electrochemical oxidation-reduction treatment, electrochemical treatment involving acid-base interactions, electrochemical treatment involving formation of insoluble compounds, electrochemical precipitation, electro coagulation, electro flocculation, treatment with pondermotive forces, treatment with electrophoresis, treatment with electro dialysis, treatment in strong electromagnetic fields, treatment in plasma streamers, particle interception in electromagnetic fields, and combinations thereof.

Two embodiments described above are designated as “wastewater treatment” and “water purification”. This, however, should not be construed as a limitation on the use of these processes. Both processes and their combinations as well as any modification described in other sections of the present application can be used for water purification, for wastewater treatment and for treatment of other categories of water solutions. These processes can be used for in-sewer, or in-pipe treatment of water. Particularly, the iron-loaded biomass from the first embodiment can be fed in sewer lines. The biomass in sewer lines would consume the organic matter, especially the products of acidogenic degradation of pollutants, while iron would bind hydrogen sulfide and buffer the pH. Sludge from the water purification can also be beneficially discharged in the sewers. Both, biological and physical-chemical iron loaded sludges could also be disposed in a sanitary landfill, wherein the dual benefits of sludge disposal and of improved refuse stabilization in the landfill would be realized.

Various modifications of the described processes can be used by skilled in arts without departing from the letter and spirit of the present teaching.

What is claimed is:

1. A method of water treatment for removal of pollutants comprising steps of
(a) treatment of said water producing an intermediate effluent,
(b) treatment of said intermediate effluent with a sacrificial metal and producing ions of said sacrificial metal, whereby a thoroughly treated effluent is produced,
(c) recuperating said sacrificial metal ions generated in said step (b) and recycling said recuperated ions in said step (a),
whereby in said step (a) said pollutants are at least partially treated and removed,
whereby said recuperated and recycled ions from said step (c) improve treatment efficiency of step (a) by additionally removing said pollutants from said intermediate effluent using said recuperated ions, resulting in cleaner intermediate effluent, and
whereby, due to said cleaner intermediate effluent, the pollutant loading rate in said step (b) is reduced, intermediate effluent is treated more thoroughly, and the demand for said sacrificial metal in said step (b) is reduced, and
whereby the combination of said steps (a), (b) and (c) produces a synergistic effect resulting in improved removal of said pollutants and in reduced need in said sacrificial metal.

2. The method as described in claim 1 wherein said water is selected from the group comprising sewage, wastewater, domestic wastewater, municipal wastewater, industrial wastewater, commercial wastewater, animal farm wastewater, agricultural wastewater, wastewater from ground transportation vehicles, wastewater in space ships, partially treated wastewater, wastewater sludge, biosolids, storm water, surface runoff, water from surface water supply sources, river water, lake water, brackish water, sea water, industrial process water, water in industrial cooling systems, water in industrial cooling systems with recirculation, water as a solvent in industrial systems, water as a carrier in industrial systems, irrigation water, mine waters, and combinations thereof.

3. The method as described in claim 1 wherein said pollutants are selected from the group comprising nonionic species, ionic species, ionized species, non-ionized species, organic compounds, toxic organic compounds, recalcitrant organic compounds, inorganic compounds, toxic inorganic compounds, heavy metals, toxic oxygen containing ions, hydrides, dissolved substances, suspended solids, solid particles, flocculent particles, polymeric substances, nutrients, bound nitrogen, organic nitrogen, inorganic nitrogen, ammonia, nitrites, nitrates, phosphorus-containing compounds, organic phosphorus, inorganic phosphorus, phosphates, microorganisms, protozoa, bacteria, viruses, autotrophic organisms, heterotrophic organisms, and combinations thereof.

4. The method as described in claim 1 wherein said sacrificial metal is selected from the group comprising iron, nickel, cobalt, zinc, aluminum, copper, and combinations thereof.

5. The method as described in claim 1 wherein said step (a) is selected from the group comprising chemical treatment, oxidation-reduction treatment, treatment involving acid-base interactions, formation of insoluble compounds, chemical precipitation, coagulation, flocculation, gravity settling, flotation, filtration, membrane filtration, electrochemical treatment, magnetic treatment, biological treatment, biological-abiotic treatment, and combinations thereof.

6. The method as described in claim 5 wherein said biological treatment is selected from the group comprising oxygen enriched aerobic process, air-based aerobic process, nitrification process, oxidation of ferrous to ferric ions process, microaerophylic process, fermentation process, facultative process, acidogenic process, sulfate reducing process, carbonate reducing process, water reducing process, methanogenic process, and combinations thereof.

7. The method as described in claim 5 wherein said biological-abiotic treatment is selected from the group comprising oxygen enriched aerobic process, air-based aerobic process, nitrification process, oxidation of ferrous to ferric ions process, microaerophylic process, fermentation process, facultative process, acidogenic process, sulfate reducing process, carbonate reducing process, water reducing process, methanogenic process, and combinations thereof.

8. The method as described in claim 1 wherein said treatment producing intermediate effluent is selected from the group comprising periods of mixing, periods of aeration, idle periods, decanting periods, and combinations thereof.

9. The method as described in claim 1 wherein said treatment producing intermediate effluent is selected from the group comprising at least one continuous process, at least one batch process, at least one semicontinous process, and combinations thereof.

10. The method as described in claim 1, wherein said step (b) is selected from the group comprising electrochemical treatment, electrochemical treatment with direct current, electrochemical treatment with alternating current, electrochemical treatment with pulsed current, electrochemical treatment with cementation induced reactions, spontaneous electrochemical treatment, electrochemical treatment with spontaneously induced galvanic cell, electrochemical treatment with primed sacrificial metal, electrochemical treatment with activated sacrificial metal, electrochemical oxidation-reduction treatment, electrochemical treatment involving acid-base interactions, electrochemical treatment involving formation of insoluble compounds, electrochemical precipitation, electro coagulation, electro flocculation, treatment with pondermotive forces, treatment with electrophoresis, treatment with electro dialysis, treatment in strong electromagnetic fields, treatment in plasma streamers, particle interception in electromagnetic fields, and combinations thereof.

11. The method as described in claim 1, wherein an excess sludge loaded with iron compounds is generated and further providing a step of evacuating the said sludge to a beneficial sludge disposal location selected from the group comprising sewer line, sanitary landfill, arable land, non-arable land, forest, strip mine, and combinations thereof.
